(19) United States
(12) Patent Application Publication
(10) Pub. No.: US 2025/0230564 A1
(43) Pub. Date: Jul. 17, 2025

(54) METHODS AND SYSTEMS FOR THE ELECTROCHEMICAL TREATING OF IRON AND STEEL

(71) Applicants: Alliance for Sustainable Energy, LLC, Golden, CO (US); Colorado School of Mines, Golden, CO (US)

(72) Inventors: Robert Terry BELL, Lakewood, CO (US); Kerry Christine RIPPY, Golden, CO (US); Liam WITTEMAN, Irving, TX (US)

(21) Appl. No.: 19/019,169

(22) Filed: Jan. 13, 2025

Related U.S. Application Data
(60) Provisional application No. 63/619,961, filed on Jan. 11, 2024.

(51) Int. Cl. C25C 3/34; C25C 7/02; C25C 7/06

(52) U.S. Cl. CPC C25C 3/34; C25C 7/025; C25C 7/06

(57) ABSTRACT

The present disclosure relates to a method that includes converting a solid containing iron and a second element to a liquid having a first phase and a second phase and separating the first phase from the second phase, where the converting includes contacting the liquid with a carbon source using an electrochemical reactor, such that the first phase comprises Fe₃C, and the second phase includes substantially all of the second element originally present in the solid.

### CROSS-REFERENCE TO RELATED APPLICATIONS

This application claims priority from U.S. Provisional Patent Application No. 63/619,961 filed on Jan. 11, 2024, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Globally, about 75% of steel is produced via reduction of iron ore with coke in blast furnaces. This process is highly inefficient, energy intensive, and produces nearly two tons of CO₂ per ton of steel produced. The US steel industry relies more heavily on electric arc furnaces (EAF). For example, the natural gas-based MIDREX® DRI process paired with an EAF has the lowest greenhouse gas emissions of any commonly deployed steel-making route. However, these natural gas-based processes still produce large quantities of CO₂ and their EAFs require 360-600 kWhₑ per ton of steel. Thus, there remains a need for improved systems and methods for steel production.

### SUMMARY

An aspect of the present disclosure is a method that includes converting a solid containing iron and a second element to a liquid having a first phase and a second phase and separating the first phase from the second phase, where the converting includes contacting the liquid with a carbon source using an electrochemical reactor, such that the first phase comprises Fe₃C, and the second phase includes substantially all of the second element originally present in the solid.

In some embodiments of the present disclosure, the carbon source may include at least one of CO₂, methane, biochar, graphite, or a combination thereof. In some embodiments of the present disclosure, the second element may include at least one of Cu, Mn, Cr, Ni, Cu, Zn, Mo, Al, Li, Cd, or a combination thereof. In some embodiments of the present disclosure, the second element may be copper. In some embodiments of the present disclosure, the copper may be present in the solid at a first concentration between greater than 0 wt % and about 10 wt %. In some embodiments of the present disclosure, the iron may be present in the solid at a second concentration between 90 wt % and less than 100 wt %.

In some embodiments of the present disclosure, the converting may include heating the solid to a temperature between about 200° C. and about 1200° C. In some embodiments of the present disclosure, the solid may include a mixed waste. In some embodiments of the present disclosure, the solid may include an alloy of iron and the second element. In some embodiments of the present disclosure, the converting may be performed by immersing the solid in an electrolyte. In some embodiments of the present disclosure, the converting may include heating the solid while immersed in the electrolyte.

In some embodiments of the present disclosure, the electrolyte may include at least one of a molten salt, a molten metal oxide, or a combination thereof. In some embodiments of the present disclosure, the solid may be configured to operate as a cathode in the electrochemical reactor. In some embodiments of the present disclosure, the cathode may be connected electrically to an anode. In some embodiments of the present disclosure, the anode may be constructed of at least one of a metal, a conductive oxide, a conductive glass, a conductive ceramic, graphite, or a combination thereof.

In some embodiments of the present disclosure, the anode may further include a catalyst. In some embodiments of the present disclosure, the separating may be achieved by a density difference between the first phase and the second phase. In some embodiments of the present disclosure, the CO₂ may be introduced to the electrochemical reactor by a pipe, a sparger, or a combination thereof. In some embodiments of the present disclosure, the pipe or sparger may direct the CO₂ below a liquid level of the electrolyte, resulting in the formation of CO₂ bubbles, where the bubbles cause the electrolyte to mix.

An aspect of the present disclosure is an electrochemical reactor that includes a vessel; a cathode; an anode; an electrolyte; a separator; and a pipe and/or sparger.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 illustrates a schematic of the proposed route system for producing carbon-neutral steel, according to some embodiments of the present disclosure.

FIG. 2 illustrates: Panel A) Phase diagram of C—Fe as a function of temperature showing the high solubility of carbon in the austenite phase at 800° C.; Panel B) The C—Cu—Fe phase diagram at 717° C. showing the formation of discrete Cu and Fe₃C phases, according to some embodiments of the present disclosure. At higher carbon contents the ratio of Fe₃C to Fe increases until all iron is in the carbide phase.

FIG. 3 illustrates a reactor for carburizing mild steel and/or iron and/or for recovering other metals from a mixture containing iron, according to some embodiments of the present disclosure.

FIG. 4 illustrates a photograph of a bucket furnace setup, according to some embodiments of the present disclosure.

FIG. 5 illustrates a schematic of reactor set up showing crucible containing salt in the bucket furnace, shown with side view top-down view, according to some embodiments of the present disclosure. Electrodes are submerged in the solid salt prior to melting.

FIG. 6 illustrates (Panel A) cyclic voltammetry results and (Panel B) current response of electrochemical carburization of mild steel, according to some embodiments of the present disclosure.

FIG. 7 illustrates optical images of carburized mild steel, according to some embodiments of the present disclosure.

FIG. 8 illustrates an SEM image of carburized mild steel containing Pearlite, according to some embodiments of the present disclosure.

FIG. 9 illustrates SEM images of carburized mild steel as a function of distance from the surface of the starting mild steel cathode, according to some embodiments of the present disclosure.

FIG. 10 illustrates SEM images of carburized mild steel, showing the formation of Pearlite as a function of distance from the surface of the starting mild steel electrode, according to some embodiments of the present disclosure.

FIG. 11 illustrates a quantification of cementite content in carburized mild steel as a function of distance from the surface of the starting mild steel electrode, according to some embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### REFERENCE NUMERALS

100 . . . system
105 . . . iron ore (Fe₂O₃)
107 . . . hydrogen (H₂)
110 . . . furnace
112 . . . iron (Fe) and/or iron-containing stream
114 . . . water (H₂O)
116 . . . carbon dioxide (CO₂)
120 . . . electrochemical reactor
122 . . . two-phase mixture
124 . . . oxygen (O₂)
130 . . . separation unit
132 . . . iron carbide (Fe₃C)
134 . . . other metal(s) (e.g., copper)
300 . . . vessel
310 . . . anode
320 . . . cathode
330 . . . electrolyte
340 . . . pipe/sparger
350 . . . separator
360 . . . power supply
370 . . . electrical connection

### DETAILED DESCRIPTION

The present disclosure relates to methods and systems for treating iron and steel. In some embodiments of the present disclosure, an electrochemical reactor may be designed to carbonate scrap iron and/or recycled steel. In some embodiments of the present disclosure, the carbon source for the carbonation may be provided by at least one of CO₂, methane, and/or graphite. In some embodiments of the present disclosure, an electrochemical reactor be designed to treat a mixture that includes iron and one or more other metals (e.g., copper) to produce a relatively pure carburized iron phase and a phase enriched with the one or more other metals. Once formed the phases may be separated using one or more downstream unit operations to form a first stream containing relatively pure iron carbide (Fe₃C) and a second stream containing the other metals.

In some embodiments of the present disclosure, an electrochemical reactor or system may be combined with hydrogen direct reduction of iron (HDRI). This approach may reduce greenhouse gases by 100% to achieve net-zero steel production. For example, HDRI billets and/or scrap steel may be electrochemically reacted with CO₂ (or other carbon source) in a molten carbonate salt electrolyte at 800° C. to produce Fe₃C (i.e., iron carbide, cementite). The Fe₃C may then be mixed with iron or mild steel and heat treated to achieve a target carbon content in a crude steel product. In some embodiments of the present disclosure, a furnace designed for hydrogen direct reduction of iron (HDRI) may produce iron which is subsequently directed to an electrochemical reactor designed to convert the HDRI iron and/or other iron and/or steel to Fe₃C.

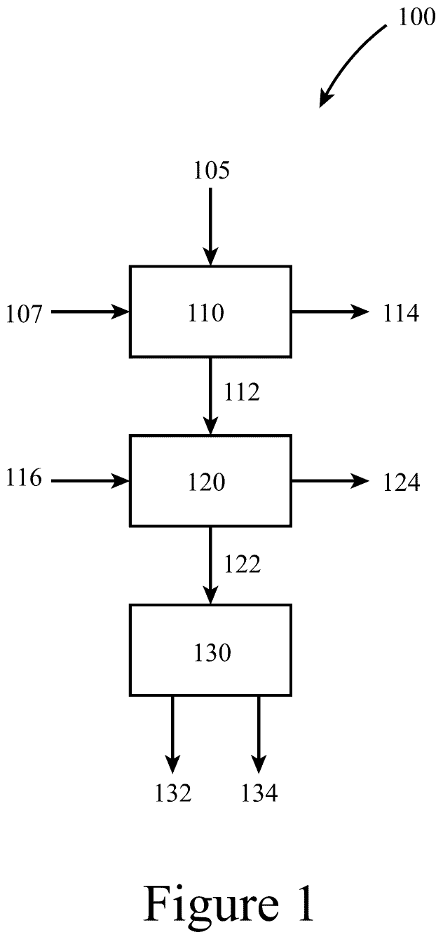

An example of such a system 100 is illustrated in FIG. 1, which shows a furnace 110 configured to reduce iron ore (Fe₂O₃) 105 to iron (Fe) 112 utilizing hydrogen (H₂) 107 as a reductant and producing water (H₂O) 114 as a byproduct. In some embodiments of the present disclosure, the hydrogen 107 may be sourced from a water splitting process (not shown) powered using renewable electricity (e.g., from solar and/or wind sources). In some embodiments of the present disclosure, the hydrogen 107 produced upstream of the furnace 110 may also be used to produce the heat needed by the furnace 110 to reduce the iron ore 105 to iron 112. In some embodiments of the present disclosure, the water 114 byproduct may include unreacted H₂. This unreacted H₂ may be separated from the water in a downstream separator (not shown), enabling the recovered H₂ to be recycled to the furnace 110 to be used as reductant and/or fuel to heat the furnace 110.

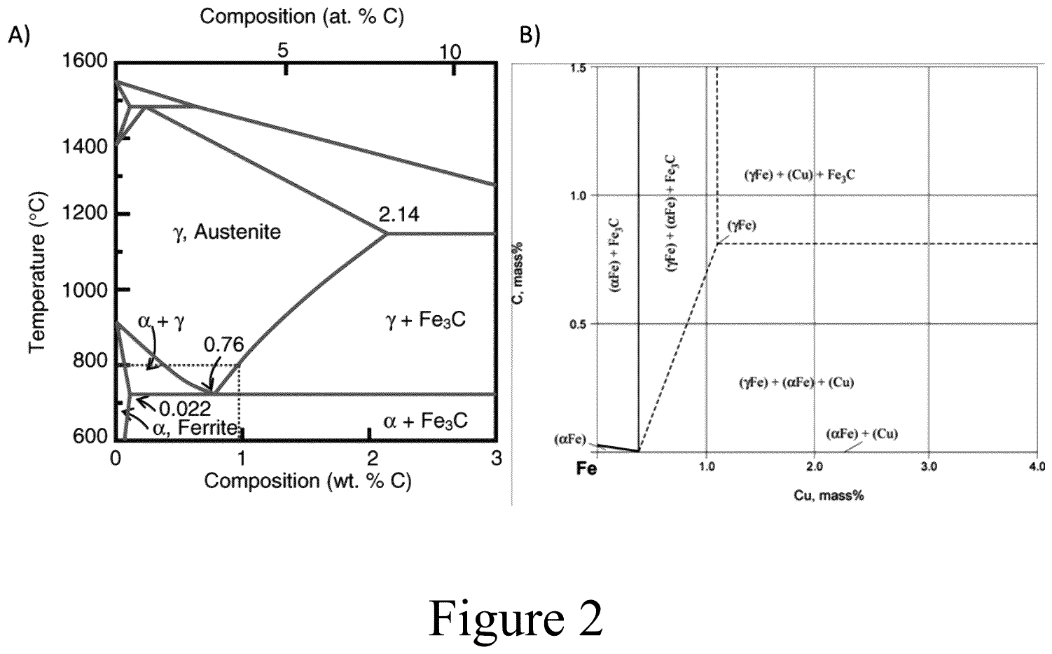

Referring again to FIG. 1, the iron 112 produced in the furnace 110 may be directed to a downstream electrochemical reactor 120 configured to carburize the iron 112 using carbon dioxide (CO₂) 116 to ultimately produce a stream of iron carbide (Fe₃C) 132 and, in some embodiments of the present, a second stream containing the recovered other metal(s) 134 (e.g., copper) that were originally contained in the source iron 112 directed to the electrochemical reactor 120. Embodiments of electrochemical reactors 120 configured to carburize iron 112 using carbon dioxide 116 are provided in detail below. However, the design of such electrochemical reactors 120 are based on thermodynamics and the preferential formation of both Fe₃C and Cu phases as illustrated in the C—Cu—Fe phase diagram illustrated in Panel A of FIG. 2. The proposed selective carbide formation technique is supported by the preferential formation of iron carbide over copper carbide across the phase space. Additionally, the separation potential of selective Fe₃C formation is supported by the solubility of Cu in the Fe₃C being below detectable limits (<0.001 wt. %) as illustrated in Panel B of FIG. 2).

Thus, referring again to FIG. 1, iron 112 from a furnace 110 and/or from other sources (e.g., recycled iron and/or steel) may be directed to an electrochemical reactor 120 configured to carburize the iron 112 using carbon dioxide 116 to produce a two-phase mixture 122 and oxygen 124 as a byproduct. The two-phase mixture 122 may include a first liquid/molten phase containing iron carbide and a second liquid/molten phase containing the other metal(s) (e.g., copper). The two-phase-mixture 122 may be subsequently directed to a separation unit 130 (described more below) configured to separate the two liquid/molten phases to produce a stream of iron carbide 132, free or mostly free of the other metals and a second stream containing all or most of the other metal(s) 134, e.g., copper.

Referring again to FIG. 1, it should be noted that in some embodiments of the present disclosure, a system 100 may not include a furnace 110 that produces iron 112. In some embodiments of the present disclosure, a system 100 may include an electrochemical reactor 120 that is used to carburize many different types of iron-containing metals, including scrap metal, recovered metal, recycled metal, etc. Thus, in some embodiments of the present disclosure, a feed stream 112 to an electrochemical reactor 120 may be any iron-containing material, with or without other metals 134. In some embodiments of the present disclosure, an electrochemical reactor 120 as described herein may be used solely to carburize an iron-containing stream 112. In some embodiments of the present disclosure, an electrochemical reactor 120 as described herein may be used carburize an iron-containing stream 112 and to separate the carburized iron from other metals, e.g., copper.

Further, a feed stream 112 to an electrochemical reactor 120 may be in a solid form, whether iron produced in a furnace and/or some other iron-containing material that is being recycled. Other forms are possible for a feed stream, e.g., liquid or molten materials. As used herein, a molten material is in a liquid form; e.g., pourable, etc.

Therefore, carburization of iron and/or steel and/or the separation of iron from other metals as described herein may be achieved using electrochemical reactors 120 designed to utilize at least one of the following features:
1) Use of electricity (applied potential) to efficiently access specific desired phases;
2) Use of a molten salt and/or molten oxide electrolyte, enabling fast mass transfer leading to fast reaction kinetics, high faradaic efficiency, and in some cases, stabilized intermediates; and/or
3) Use of CO₂ as a carbon source and electrochemical reactant to form desired phases, providing long-term carbon sequestration in the final product.

In some embodiments of the present disclosure, a combination of these features may be used to separate copper as the metal impurity from at least one of iron and/or steel scrap. Similar methods and/or systems may be successfully employed in other applications, including but not limited to purification of other metallic waste streams such as electronics and battery recycling. Metals which may be selectively recovered from iron and/or steel as described herein, in place of and/or in addition to copper, include but are not limited to other elements including at least one of Mn, Cr, Ni, Cu, Zn, Mo, Al, Li, and/or Cd.

As described herein, selective electrochemical carbide formation utilizing an electrochemical reactor 120 and/or a downstream separation unit 130 as described herein may be used to separate iron from copper in scrap blends. In some embodiments of the present disclosure, a rod formed from compressed scrap could be used as an electrode in an electrochemical reactor. Immersing this electrode in a molten salt electrolyte, applying a voltage, and providing a source of carbon such as CO₂ will cause Fe₃C and Cu to form. The electrochemical Fe₃C formation may follow Reactions [1-4].

In Molten-Salt O²⁻+CO₂ (g) [symbol] CO₃²⁻ Reaction [1]

Iron Cathode: CO₃²⁻+Fe+4e⁻ [symbol] C—Fe+3O²⁻ Reaction [2]

Anode: 2O²⁻ [symbol] O₂ (g)+4e⁻ Reaction [3]

Overall: CO₂+Fe [symbol] C—Fe+O₂ (g) Reaction [4]

In some embodiments of the present disclosure, subsequent separation of copper from Fe₃C in a separation unit 130 may be carried out using thermophysical properties such as differences in density or melting points. The lower density of Fe₃C (7.73 g/cm3) compared to both solid Cu (8.96 g/cm3) and molten Cu (7.9 g/cm3) may be leveraged. The lower density of Fe₃C means that it may float to the top in either a copper-based melt, such as pure copper or one of many copper-eutectics or could be separated from solid copper using a liquid with a density of ≈8 g/cm. A copper-eutectic based melt separation is the simplest approach, with the eutectic-forming element chosen based on both or either: 1) not alloying with Fe₃C, or 2) selecting an element used in steel production that would be tolerable as an Fe₃C impurity (such as Si or Mn). Another possible separation approach that may maintain a high-purity of the separated Cu is melt-separating pure Cu at a temperature between the melting point of Cu at 1084° C. and the typical decomposition temperature of Fe₃C at 1147° C. Similar approaches may be utilized to separate other target metals (e.g., Mn, Cr, Ni, Cu, Zn, Mo, Al, Li, and/or Cd) from Fe₃C.

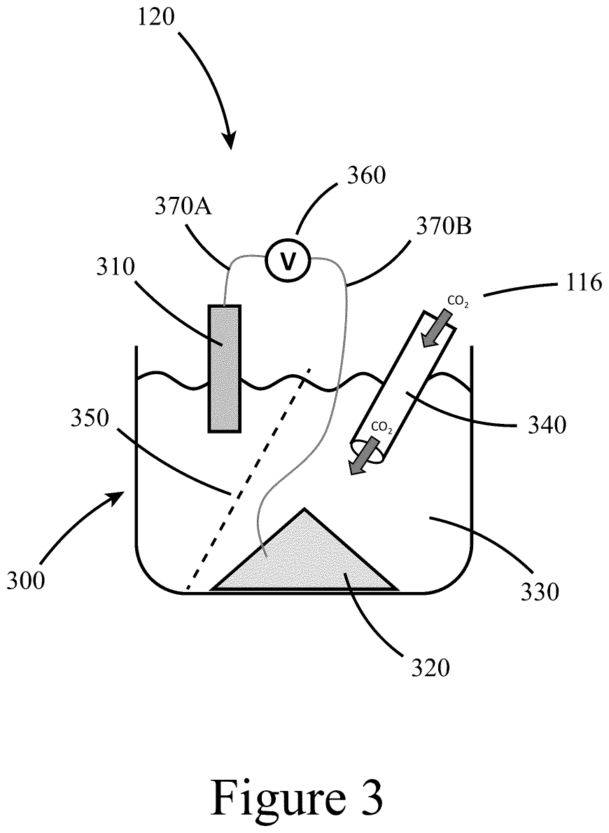

Aspects of an electrochemical reactor 120 are illustrated in FIG. 3 and described below. As illustrated in FIG. 3, in some embodiments of the present disclosure, an electrochemical reactor 120 may include a vessel 300 designed to contain an electrolyte 330. At least partially immersed in the electrolyte 330 is an anode 310 and a cathode 320. The anode 310 and the cathode are electrically connected to a power supply 360 via electrical connections 370A and 370B. A separator 350 is positioned in the electrolyte 330 between the anode 310 and the cathode 320. Finally, the electrochemical reactor 120 may include a piper/sparger 340 configured to direct carbon dioxide 116 into the electrolyte 330.

Referring again to FIG. 3, the primary tasks of the anode 310 of an electrochemical reactor 120 are to conduct and provide electricity and to enable surface reactions, in particular, the anodic reaction (see Reaction [3] above). In the case of CO₂→metal carbide or metal+carbon solid-solutions, 50-100% by weight of carbonate salts are used in the electrolyte, with the remainder of the electrolyte being some addition of other soluble salts (often a metal chloride, primarily CaCl₂), and split CO₂ to form a carbon-containing product (like iron carbide or mild carbon steel). Catalysts (not shown) change the activation energy of the reaction occurring at their location, so oxygen evolution reaction (OER) catalysts are desirable at the anode 310 to evolve molecular oxygen (O₂). As an example, an oxide material may have some impact on the OER activation energy and could broadly be considered a catalyst, though maybe not a superior performing one. To be electrically conductive, an anode 310 may be constructed wholly or in part of any electrically conductive material (though tailoring the conductor would be a good idea for extended lifetime of the system).

Examples of electrically conductive materials which may be used to construct an anode 310 include metals (e.g., molybdenum, nickel, stainless steel), conductive oxides (e.g., SnO₂), a conductive glass (e.g., an amorphous glass such as an In—Ga—Zn—O glass and/or an In—Zn—O glass), a conductive ceramic (e.g., oxides such as SnO₂, nitrides such as TiN, carbides such as SiC, and/or borides such as BN), and/or graphite. Although graphite and other carbonaceous materials may be used to construct an anode 310, the use of carbonaceous materials may result in CO₂ formation instead of O₂, resulting in the gradual loss, i.e., consumption, of the anode.

An anode 310 may be constructed as a monolithic piece of a single material, a porous structure (e.g., like a sponge or mesh), or a composite comprised of an electrically conductive fraction and a catalytically active fraction, according to some embodiments of the present disclosure. In the composite case, a conductor may be any electrical conductor, provided the catalyst fraction is catalytically active for OERs. Thus, catalysts of interest are OER catalysts. In some embodiments of the present disclosure, an OER catalyst may have the physical form of a continuous coating, a surface dusting of particles, and/or larger pieces of catalytically active material embedded in the anode, and/or other form factors. For the example of a composite, any of the electrically conductive materials described above may be used. Examples of catalyst materials include a variety of metal oxides (e.g., SnO₂ and/or IrO₂), TiN and/or a metal (e.g., Au, Ni, Pt, and/or Ag).

In some embodiments of the present disclosure, the size and shape of an anode 310 may be designed to maximize contact with the electrolyte 330. In some embodiments of the present disclosure, an anode 310 may be partially submerged in an electrolyte 330 or totally submerged. In some embodiments of the present disclosure, an anode 310 may be constructed using a plurality of rods, e.g., between 1 and 100 rods, the plurality having the approximate shape of a comb, with each rod immersed in the electrolyte 330. Thus, an anode 310 may be a single monolithic piece of the same material, e.g., a single rod as illustrated in FIG. 3, or a number of discrete anodes electrically connected to each other. Alternatively, an electrochemical reactor 120 may include more than one physical anode 310 and/or groups of anodes 310, in addition to more than one electrical circuit (not shown), with each circuit having one or more anodes. In some embodiments of the present disclosure, the surface area of an anode 310 may be greater than the surface area of the cathode 320. This may ensure that Reaction [2] above is not limited by the anode surface area.

An anode 310 should demonstrate limited or no degradation under the intended temperatures, surface chemistries, and applied electrochemical potentials. If an anode 310 is constructed completely using a single material, then that single material should be stable under all operating conditions. However, if an anode 310 is constructed using a coating and/or a composite, temperature stability is important for all the materials making up the anode 310, while maintaining the electrochemical stability for a first fraction of the anode 310, e.g., the material(s) involved with the electrochemistry, while lessening the electrochemical stability requirements for a second fraction of the anode 310, e.g., the core not exposed to the electrolyte 330. Similarly, depending on the quality of a coating, one could construct an anode 310 having any temperature-stable conductor core coated with a chemically and temperature resistant coating.

In some embodiments of the present disclosure, an anode 310 may be stable at elevated temperatures, at least at an operating temperature between 800° C. and 900° C. In some embodiments of the present disclosure, for broader applications including separating Cu and Fe₃C, an anode 310 may operate stably at an operating temperature between 800° C. and 1150° C. In some embodiments of the present disclosure, the desirable reactions may be substantially and/or completely limited to the anode surface. For example, referring again to Reaction [3], the anode material is not illustrated as a reactant or product. So, it is desirable that an anode 310 does not change appreciably during the reaction. Some chemical compatibilities of interest are: Compatibility between any part of the anode 310 in contact with the electrolyte 330. For example, when using a carbonate molten salt as an electrolyte 330 and targeting the formation of Fe₃C on the cathode 320, an anode 320 constructed of calcium metal is likely not the best choice of material at an operating temperature of about 800° C. because CaCO₃ would likely form at the anode surface, instead of the intended reactions. Another example, if one included chloride salt in the electrolyte 330, ceramic conductors may be a good choice of material of construction for the anode 310, rather than most metals, since most metals can form chlorides (although certain metals, like gold, would likely function properly, but at a high cost).

Compatibility with the reactant(s) and product(s) of the anodic reaction of interest. Referring again to the table, O²⁻ ions are oxidized to O₂; an easily oxidized metal would not be a good anode material because it would instead react with the O²⁻ to form a metal oxide. For example, an iron anode would not be a good material of construction, because it would likely result in the occurrence of an unwanted reaction:

Fe+O²⁻ [symbol] FeO+2e⁻ Reaction [5]

Further, an anode 310 should not degrade (e.g., react and/or change its composition, form, or shape) at the voltages applied by the power supply 360.

Referring again to FIG. 3, in some embodiments of the present disclosure, an electrolyte 330 may include at least one of a molten salt and/or a molten oxide. In some embodiments of the present disclosure, a molten salt and/or molten oxide may further include the molten and/or dissolved moieties of at least one of the following:
i. Carbonates: e.g., Li₂CO₃, K₂CO₃, Na₂CO₃, MgCO₃, CaCO₃, FeCO₃;
ii. Hydroxides: NaOH, KOH, Ca(OH)₂;
iii. Oxides: e.g., MgO, Na₂O, K₂O;
iv. Halides: NaCl, CaCl₂, KF, SrBr₂;
v. Bicarbonates: NaHCO₃, LiHCO₃; and/or
vi. Perchlorates, formates, imidazoliums, pyrrolidiniums, borohydrides.

In some embodiments of the present disclosure, a carbonate-containing molten salt may be doped with an MgO to increase the concentration of O²⁻ ions which would increase the reaction rates Reactions [1] and [3]. In some embodiments of the present disclosure, MgO and/or CaO could also be used. For these concepts using carbon dioxide 116 and producing a carbon-containing product, one would likely want to use an electrolyte 330 with a molten salt mixture that includes at least one of a carbonate salt and/or a bicarbonate salt.

In some embodiments of the present disclosure, the gaseous atmosphere, i.e., head-space, above the electrolyte 330 may be completely water-free. In some embodiments of the present disclosure, the head-space above the electrolyte 330 may include at least one of an inert element (e.g., helium, argon, xenon, etc.), CO₂, and or O₂.

In some embodiments of the present disclosure, an electrolyte 330 may be mechanically agitated and/or carbon dioxide 116 bubbled through the electrolyte 330 to increase amount of Reaction [1] occurring, e.g., to increase the uptake of CO₂. CO₂ bubbling increases the surface area of the CO₂/electrolyte interface where Reaction [1] occurs. Agitation may be good in general for spreading the CO₃²⁻ that gets formed in Reaction [1] throughout the electrolyte 330. In some embodiments of the present disclosure, carbon dioxide 116 may be directed to and mixed in an electrolyte 330 using a pipe and/or sparger 340; e.g., a sparger in a bubble column reactors. Of course, a pipe/sparger 340 should be constructed of a material that is stable at the operating conditions when immersed in the electrolyte, e.g., metal oxide ceramics including aluminates and silicates, or stable metals such as stainless steel.

In some embodiments of the present disclosure, the iron and/or steel to be carburized is used as the cathode 320 in the electrochemical reactor 120. Referring again to FIG. 3, a cathode 320 may be positioned at the bottom of the vessel 300, which may result in simpler insertion and/or removal of the cathode 320 from the vessel 300. Gravity may keep the collection of discrete pieces of metal comprising the cathode in intimate contact, which would maintain a low electrical resistance between the entirety of the cathode. A conductive pad with an electrical connection outside of the reactor vessel (not shown) located on the bottom of the vessel 300 could be used to make electrical contact with the pile of metal comprising the cathode 320 to further minimize the electrical resistance of the cathode and connection of the cathode to external circuits. In some embodiments of the present disclosure, one could pre-shape iron pieces prior to the pieces being immersed in the electrolyte 330. In some embodiments of the present disclosure, a cathode 320 may be constructed by pre-pressing scrap iron and/or steel into a denser cathode (like a compacted car). For carburizing iron/steel components, one could immerse them in the electrolyte 330 by positioning the cathode 320 in the electrolyte 330 by entry into through the top of the vessel 300. Scrap metal for a cathode 320 may be a variety of different sizes. So, in some embodiments of the present disclosure, a mixture of different sized scrap metal may be placed inside a “crab-trap” basket. In some embodiments of the present disclosure, if the scrap metal is a fine powder/particulate, it may be placed at the bottom of the vessel 300 and contacted via the previously described contact pad.

Referring again to FIG. 3, a separator 350 may be positioned between the electrodes and the CO₂ being introduced so that the O₂ evolved at the anode 310 is not mixed with the carbon dioxide 116 being introduced into the reactor 120. A separator material of any metal or ceramic capable of maintaining contact with the molten salt electrolyte could be used to separate the head space (gas volume above) the molten electrolyte into a volume above where CO₂ is bubbled under and evolves and a volume above the anode where O₂ is collected.

Referring again to FIG. 3, in some embodiments of the present disclosure, an electrical connection (370A and/or 370B) may come out the side or bottom of the vessel 300. For example, for the cathode 320 illustrated in FIG. 3, an electrical connection may exit the vessel 300 at the bottom of the vessel 300. In some embodiments of the present disclosure, an electrical connection 370B may be an insulated wire passing through the electrolyte 330 as shown in FIG. 3. That method can eliminate the need for hole in a wall of the vessel 300. In some embodiments of the present disclosure, a power supply 360 may provide a voltage between about between −1.4 V, and −4 V or between −1.4 V and −2.4 V, may be applied across the electrodes.

### Experimental Methods:

Materials: The electrolytes used were lithium carbonate (≥99%, Sigma Aldrich), and potassium carbonate (≥99%, Sigma Aldrich). The cathodes used were mild steel rods (AISI 1018, diameter: 2 mm; length: 300 mm, McMaster-Carr) and conductive graphite rods (diameter: 6.35 mm; length: 300 mm, McMaster-Carr). The anodes used were tin oxide SnO₂ rods (purity: 98.5%; diameter: 10 mm; length: 300 mm, Dyson Industries Ltd.).

Alumina sheaths and crucibles were purchased from AdValue Technology. These included single bore alumina tube (diameter: ¼″, length: 12″, AL-T-N1/4-N3/16-12, AdValue Technology), 2 bore hole alumina tube (diameter: ¼″, length: 18″, AL-T2-N25-N062-18, AdValue Technology), 250 ml alumina crucible (AL-1250, AdValue Technology), and 60 ml and 35 ml alumina dishes (AL-4060, AL-4025, AdValue Technology).

Salt preparation: Salts were stored and mixed in a glovebox. Salt was prepared by bulk mixing the lithium and potassium carbonate in a 1:1 molar ratio. Crucibles were pre-weighed outside the glovebox, filled within to ˜⅞ full, and sealed in airtight bags to prevent air exposure. This is done due to the high fluctuations in measuring mass inside the glovebox. Shortly before use, the filled crucibles were removed from the glovebox and weighed with the mass calculated from the mass of the empty crucible subtracted from the full crucible. Table 1 summarizes salt properties and experimental parameters investigated.

TABLE 1

| | Carbonate Salt Mixture |
|---|---|
| | (1:1 mol. % Li₂CO₃—K₂CO₃) |
| Melting Point/° C. | 503 |
| Target Temperature/° C. | 800 |
| Voltage/V | −1.8 or −2.4 |
| Cathode | Mild steel rod or graphite rod |
| Anode | Tin oxide rod |
| Expected Reaction at Anode | O₂ evolution |

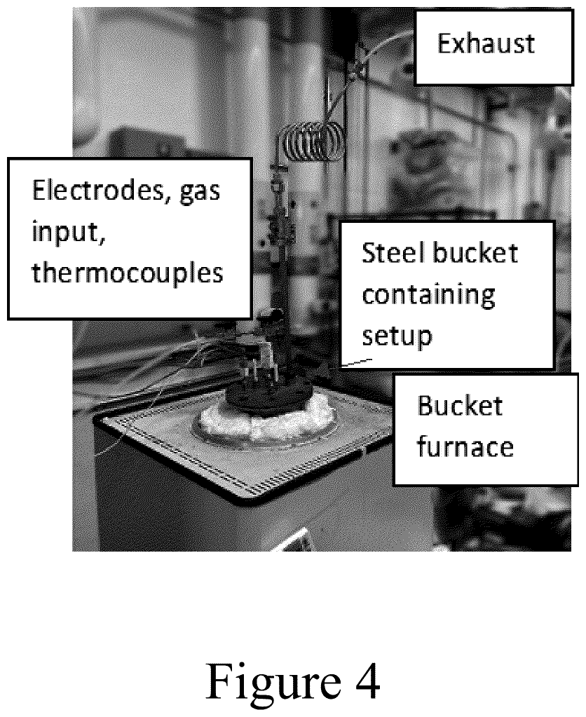

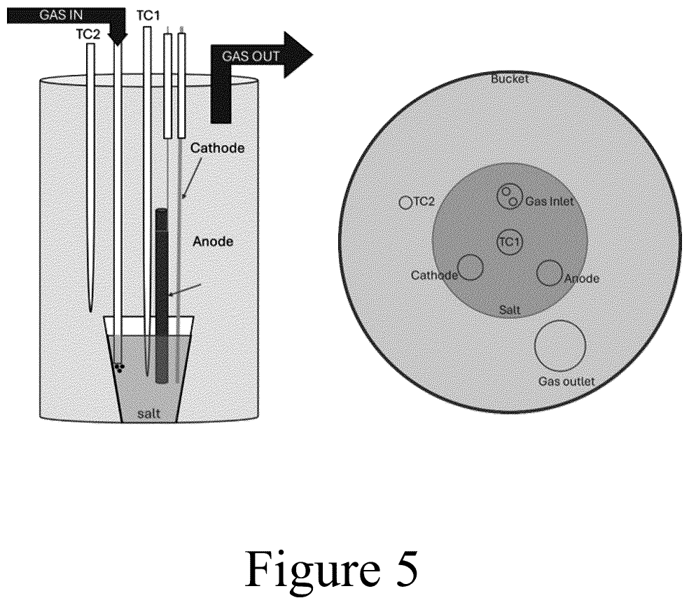

Reactor Setup: A custom stainless-steel bucket and lid was designed and used in a Thermo-Fisher Scientific CF56622C Lindberg/Blue M™ Crucible Furnace. The experimental setup used in these studies is shown in FIG. 4, and a schematic diagram shown in FIG. 5. Several fittings are welded into place on the lid. An alumina crucible was filled with the selected salt (ca. 190-200 g). The electrodes are immersed in the salt and attached via copper wire, which is then threaded through the lid of the bucket with alumina tube sheaths to insulate the wires and prevent shorting through the lid. The alumina sheaths are passed through the lid of the bucket and held with ¼″ Swagelok fittings using Teflon ferrules. To seal the area around the copper wires, a 1/16 in to ¼″ Swagelok union with PTFE ferrules was used.

In addition to the electrodes, two closed-end alumina sheaths with type-K thermocouples are inserted into the bucket. One thermocouple is placed in the center and immersed in the salt (TC1) and the other is off-center and outside of the salt radially (TC2). Finally, a ¼″ gas inlet line is attached to a multiple-bore hole alumina tube to pump gas into the apparatus. The alumina tube can be placed to accommodate for gas flow through the salt or into the headspace, depending on experimental needs. A gas outlet line with a ⅜″ diameter is attached at the top of the lid. All alumina sheaths and tubes are held in place on the bucket lid with ¼″ Swagelok fittings and Teflon ferrules. Inert gas was pumped into the apparatus for ˜12 h at a flow rate of 90 scm to purge the reactor. A schematic of the reactor is shown in FIG. 5. Leaks were checked using a GL Sciences Inc® Leak Detector LD239 to detect argon coming from any openings in the lid.

The electrodes were attached in a 2-electrode configuration with alligator clips to an Autolab Vionic Potentiostat/Galvanostat 3500001080) for electrochemical measurements and data was collected with Intello software. The measured voltages are internally referenced against the oxygen evolution occurring at the anode.

Experimental Procedure: The experimental procedure used is summarized as follows:
1. Furnace program started under inert gas flow at 150 scm and heats to 200° C. at a rate of 5.83° C./min. This temperature was held for 1 hour to release any absorbed water. The furnace then proceeded to heat to the target temperature of 800° C. at a rate of 4° C./min before being held at that temperature for 1 hour to ensure thermal equilibration in the bucket before electrochemical work begins.
2. The open circuit potential (OCP) was measured for ˜1 h to monitor the cell. If needed, cyclic voltammetry (CV) was cathodically scanned at 10 mV/s from −1V to −2.4 V. This step checked for a complete electrochemical circuit and determined the appropriate potential at which reactions will take place.
3. Chronopotentiometry at a set voltage (−1.8 V or −2.4 V) was run for 28 minutes.
4. Once the electrochemical measurements were completed, the voltage was turned off and the potentiostat and leads were disconnected. Electrodes were lifted from the molten salt pulling up the copper wire through the lid of the furnace but were not removed from the bucket completely, instead dangled in the headspace above the molten salt.
5. The furnace was then cooled naturally to room temperature.

Table 2 summarizes the experiments that were completed using this procedure:

TABLE 2

| Experiment # | Experiment variable |
|---|---|
| 1 | −2.4 V applied |
| 2 | −1.8 V applied |
| 3 | Heat treated; no voltage applied |
| 4 | Untreated |

### Experimental Results:

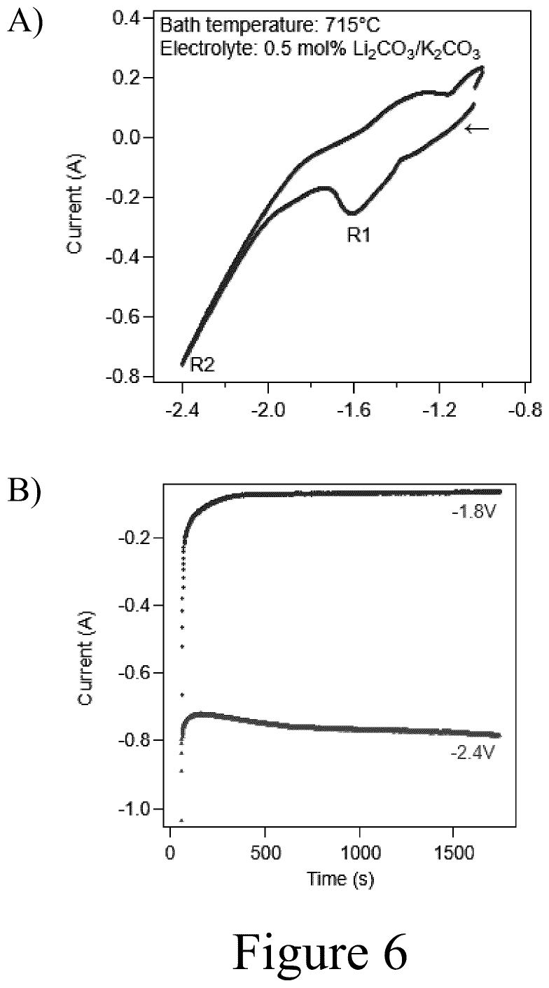

FIG. 6 illustrates (Panel A) cyclic voltammetry results and (Panel B) current response of electrochemical carburization of mild steel, according to some embodiments of the present disclosure. Panel A illustrates that the minimum possible potential to observe reduction event R1 (the reaction of interest) is approx. −1.4V. Panel B illustrates that at a greater applied potential, greater current is observed, which translates to a faster rate of deposition. Panel A was scanned cathodically with a scan rate of 10 mV/s. Reduction peaks are shown, labeled R1 and R2. Panel B shows the current response to 30 minutes of chronoamperometry at two voltages: −1.8 V and −2.4 V.

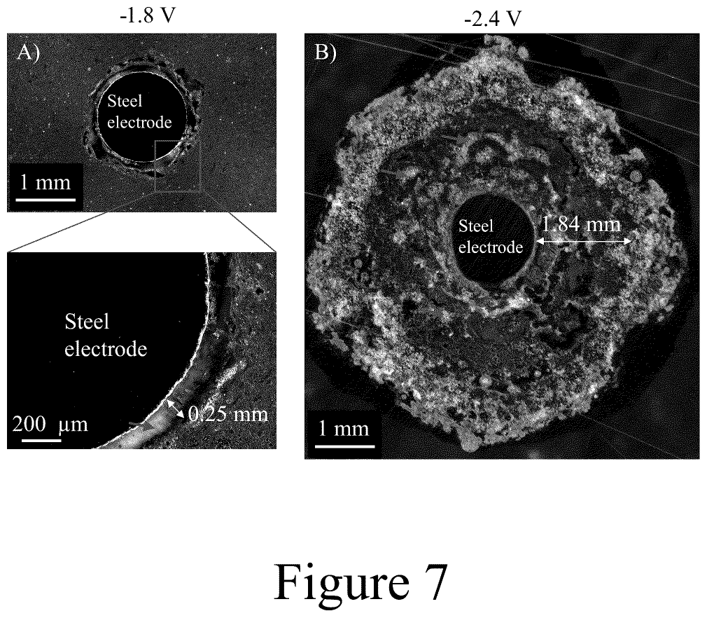

FIG. 7 illustrates optical images of carburized mild steel, according to some embodiments of the present disclosure. The left side corresponds to samples resulting from a voltage of −1.8V and the right side to samples resulting from a voltage of −2.4 V. For the −1.8 V test, a 250 μm deposit is observed, composed almost entirely of re-crystallized salt (white material, indicated with arrows). This indicates all deposited carbon was consumed by the cathode. For the −2.4 V cathode, a large (1.84 mm) deposit layer composed of both carbonaceous material (grey) and entrapped salt (white phase, red arrows). The large amount of carbonaceous material indicates that the rate of carbon deposition is higher than the rate of carbon consumption. So, greater deposition occurred at greater negative potential, consistent with the data illustrated in FIG. 6.

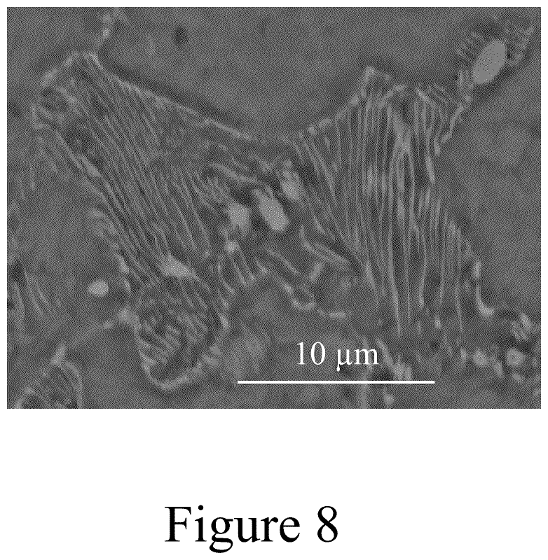

FIG. 8 illustrates an SEM image of carburized mild steel containing Pearlite, according to some embodiments of the present disclosure. The white phase is carbon-rich cementite. The gray phase is carbon-poor ferrite. Pearlite is evident by the alternating sheets (lamellae) of ferrite and cementite. The sheets can be at any angle with respect to the cross-section.

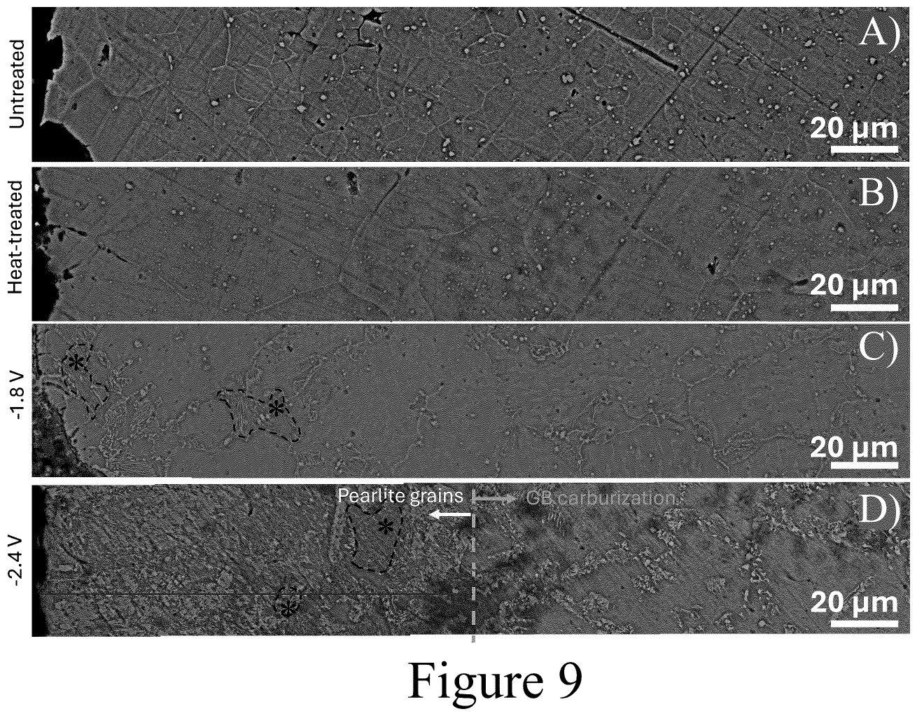

FIG. 9 illustrates SEM images of carburized mild steel as a function of distance from the surface of the starting mild steel cathode, according to some embodiments of the present disclosure. These images also further demonstrate the formation of pearlite. Electron micrographs of polished and etched electrode radial cross sections for untreated (Panel a), heat-treated (Panel b), −1.8 V test (Panel c), and −2.4 V test (Panel d). Pearlite is identified by its characteristic lamellar microstructure. Dashed areas without (*) are representative ferrite grains, dashed areas with (*) are representative pearlite grains. The −2.4 V cathode shows heavy carburization (only pearlite grains) up to the vertical dashed line at 135 μm from the surface. After this, it shows grain boundary (GB) carburization.

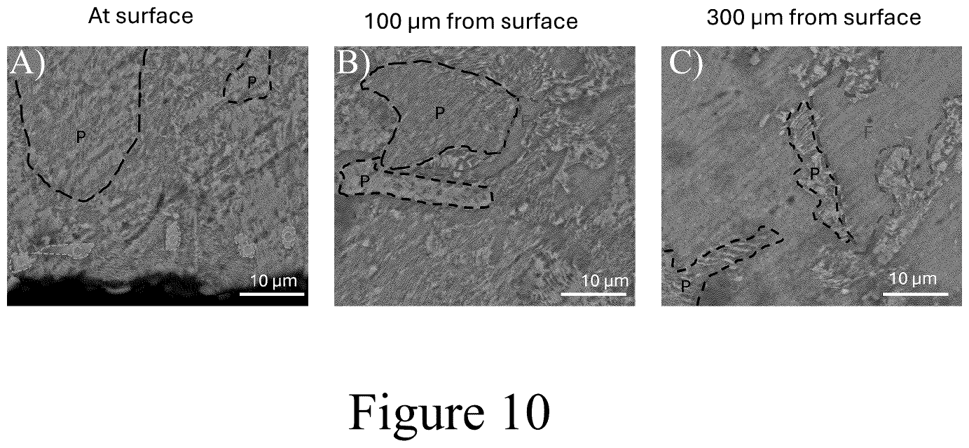

FIG. 10 illustrates SEM images of carburized mild steel, showing the formation of Pearlite as a function of distance from the surface of the starting mild steel electrode, according to some embodiments of the present disclosure. (Panel a) is an SEM image at the surface, (Panel b) about 100 μm from the surface, and (Panel c) about 300 μm from the surface. At the surface, the microstructure is primarily pearlite (dashed area, letter P), with no ferrite grains observed. There are some purely cementite (dashed area, letter C) precipitates present within 10 μm of the surface. At 100 μm from the surface, the pearlite matrix begins to change back to a ferritic matrix (dashed area, letter F), but most of the area remains pearlite. At 300 μm from the surface, the ferritic matrix is dominant, with large (>10 μm) pearlite grains observed along the ferrite grain boundaries.

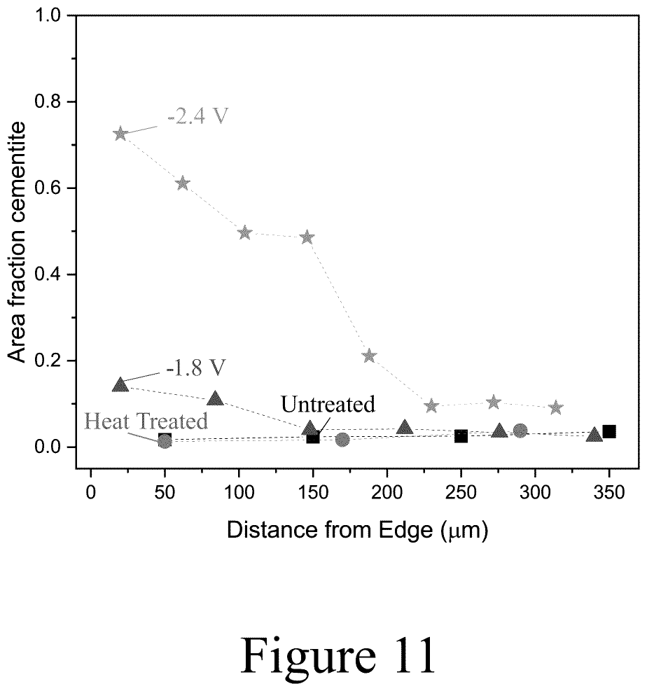

FIG. 11 illustrates a quantification of cementite content in carburized mild steel as a function of distance from the surface of the starting mild steel electrode, according to some embodiments of the present disclosure. This figure illustrates a large difference in the behavior of the −2.4 V and −1.8 V conditions and both show significant carburization near the surface.

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method comprising:
converting a solid comprising iron and a second element to a liquid comprising a first phase and a second phase; and
separating the first phase from the second phase, wherein:
the converting comprises contacting the liquid with a carbon source using an electrochemical reactor,
the first phase comprises Fe₃C, and
the second phase comprises substantially all of the second element originally present in the solid.

2. The method of claim 1, wherein the carbon source comprises at least one of CO₂, methane, biochar, graphite, or a combination thereof.

3. The method of claim 1, wherein the second element comprises at least one of Cu, Mn, Cr, Ni, Cu, Zn, Mo, Al, Li, Cd, or a combination thereof.

4. The method of claim 1, wherein the second element is copper.

5. The method of claim 4, wherein the copper is present in the solid at a first concentration between greater than 0 wt % and about 10 wt %.

6. The method of claim 5, wherein the iron is present in the solid at a second concentration between 90 wt % and less than 100 wt %.

7. The method of claim 1, wherein the converting comprises heating the solid to a temperature between about 200° C. and about 1200° C.

8. The method of claim 1, wherein the solid comprises a mixed waste.

9. The method of claim 1, wherein the solid comprises an alloy comprising iron and the second element.

10. The method of claim 1, wherein the converting is performed by immersing the solid in an electrolyte.

11. The method of claim 10, wherein the converting comprises heating the solid while immersed in the electrolyte.

12. The method of claim 10, wherein the electrolyte comprises at least one of a molten salt, a molten metal oxide, or a combination thereof.

13. The method of claim 10, wherein the solid is configured to operate as a cathode in the electrochemical reactor.

14. The method of claim 13, wherein the cathode is connected electrically to an anode.

15. The method of claim 14, wherein the anode is constructed of at least one of a metal, a conductive oxide, a conductive glass, a conductive ceramic, graphite, or a combination thereof.

16. The method of claim 15, wherein the anode further comprises a catalyst.

17. The method of claim 1, wherein the separating is achieved by a density difference between the first phase and the second phase.

18. The method of claim 2, wherein the CO₂ is introduced to the electrochemical reactor by a pipe or sparger.

19. The method of claim 18, wherein the pipe or sparger directs the CO₂ below a liquid level of the electrolyte, resulting in the formation of CO₂ bubbles, wherein the bubbles cause the electrolyte to mix.

20. An electrochemical reactor comprising:
a vessel; a cathode; an anode; an electrolyte; a separator; and a pipe and/or sparger.
